(19) United States
(12) Patent Application Publication
(10) Pub. No.: US 2025/0102380 A1
(43) Pub. Date: Mar. 27, 2025

(54) STRAIN GAUGE

(71) Applicant: MINEBEA MITSUMI Inc., Nagano (JP)

(72) Inventors: Aya ONO, Nagano (JP); Atsushi KITAMURA, Nagano (JP); Toshiaki ASAKAWA, Nagano (JP); Akiyo YUGUCHI, Nagano (JP)

(21) Appl. No.: 18/730,088

(22) PCT Filed: Mar. 24, 2022
(86) PCT No.: PCT/JP2022/014159

§ 371 Date: Jul. 18, 2024

(30) Foreign Application Priority Data
Jan. 19, 2022 (JP) 2022-006257

(51) Int. Cl. G01L 1/22; G01B 7/16

(52) U.S. Cl. CPC G01L 1/2287; G01B 7/16

(57) ABSTRACT

A strain gauge according to the present disclosure includes: a resin substrate; a resistor formed of a film containing Cr, CrN, and Cr₂N on one side of the substrate; and an inorganic insulating layer formed on another side of the substrate, and, in this strain gauge, the inorganic insulating layer is formed at least at a position overlapping a region where the resistor is formed in plan view.

### TECHNICAL FIELD

The present disclosure relates to a strain gauge.

### BACKGROUND ART

A strain gauge that has a resistor on a substrate and that is attached to an object to be measured to detect the properties of the object has been known heretofore. A strain gauge is used as a sensor for detecting material strain, ambient temperature, and so forth (see, for example, Patent Document 1).

### CITATION LIST

### Patent Document

Patent Document 1: Unexamined Japanese Patent Application Publication No. 2001-221696

### SUMMARY OF THE INVENTION

### Problem to be Solved by the Invention

There are instances where a strain gauge is formed with a resin substrate and “creep” poses a problem.

The present disclosure has been made in view of the foregoing, and aims to provide a strain gauge in which creep can be reduced.

### Means for Solving the Problem

A strain gauge according to the present disclosure includes: a resin substrate; a resistor formed of a film containing Cr, CrN, and Cr₂N on one side of the substrate; and an inorganic insulating layer formed on another side of the substrate, and, in this strain gauge, the inorganic insulating layer is formed at least at a position overlapping a region where the resistor is formed in plan view.

### Advantageous Effects of the Invention

According to the technique disclosed here, it is possible to provide a strain gauge in which creep can be reduced.

### BRIEF DESCRIPTION OF THE DRAWINGS

FIG. 1 is a plan view of an example of a strain gauge according to a first embodiment;

FIG. 2 is a cross-sectional view (example 1) that illustrates an example of the strain gauge according to the first embodiment;

FIG. 3 is a diagram for explaining a method of measuring creep and creep recovery;

FIG. 4 shows results of studying creep and creep recovery;

FIG. 5 is a cross-sectional view (example 2) that illustrates an example of the strain gauge according to the first embodiment; and

FIG. 6 is a cross-sectional view that illustrates a strain gauge according to a variation 1 of the first embodiment.

### DETAILED DESCRIPTION OF THE INVENTION

An embodiment of the present invention will be described with reference to the accompanying drawings. Parts that are the same throughout the drawings may be assigned the same or similar reference numerals. In addition, in each drawing, an X direction, a Y direction, and a Z direction that are perpendicular to each other may be defined. In this case, taking the X direction as an example, the end where the starting point (root) of the arrow is situated may be referred to as the “−X side,” and the end where the arrowhead is situated may be referred to as the “+X side.” The same holds with the Y and Z directions. In addition, in the description of the drawings, the description of parts that have been described earlier may be omitted.

### First Embodiment

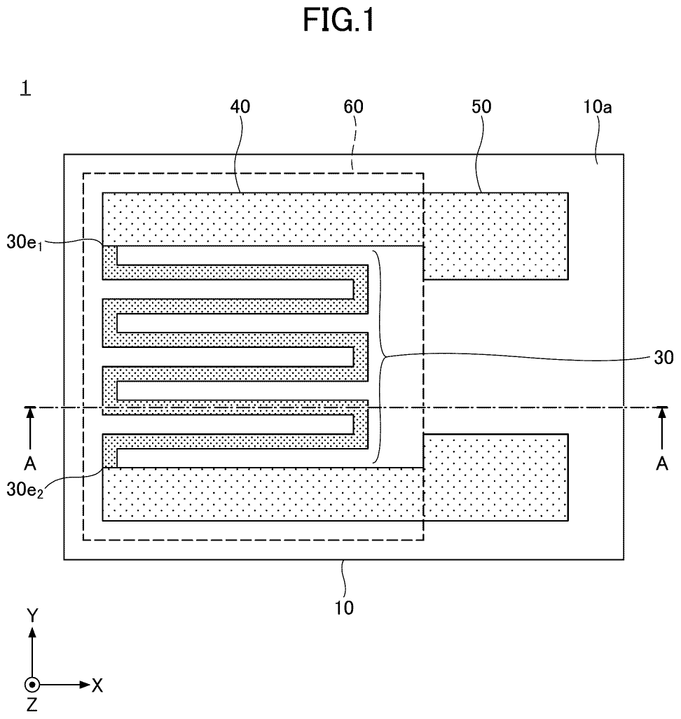

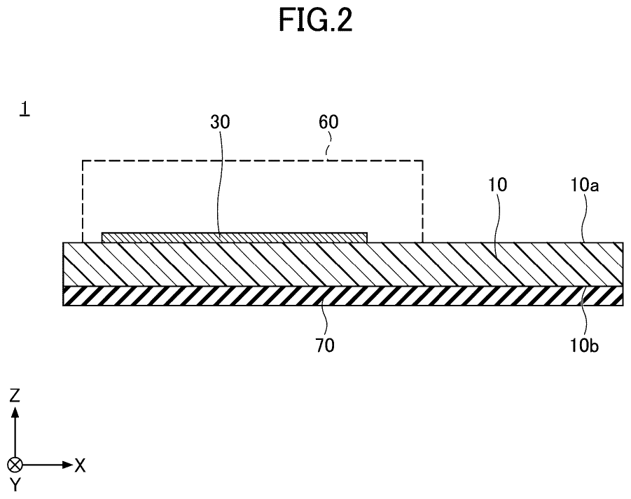

FIG. 1 is a plan view that illustrates an example of a strain gauge according to a first embodiment. FIG. 2 is a cross-sectional view (example 1) that illustrates an example of the strain gauge according to the first embodiment, showing a cross-section taken along line A-A in FIG. 1.

Referring to FIG. 1 and FIG. 2, a strain gauge includes a substrate 10, a resistor 30, conductive traces 40, electrodes 50, a cover layer 60, and an inorganic insulating layer 70. A cover layer 60 may be provided if necessary. Note that, in FIG. 1 and FIG. 2, for ease of understanding, only the outer edges of the cover layer 60 are shown using dashed lines. First, each component of the strain gauge 1 will be described in detail.

Note that, in the present embodiment, for ease of understanding, the side of the substrate 10 in the strain gauge 1 over which the resistor 30 is formed will be referred to as the “upper side,” and the side over which the resistor 30 is not formed will be referred to as the “lower side.” In addition, the surface located on the upper side will be referred to as the “upper surface,” and the surface located on the lower side of each part will be referred to as the “lower surface.” However, the strain gauge 1 can also be used upside down. Furthermore, the strain gauge 1 can be positioned at any angle. Furthermore, “plan view” as used herein means that an object is viewed from a direction normal to the upper surface 10a of the substrate 10. “Plan shape” as used herein refers to the shape of an object viewed from a direction normal to the upper surface 10a of the substrate 10.

The substrate 10 is a member that serves as a foundation layer when forming the resistor 30 and the like. The substrate 10 is flexible. The thickness of the substrate 10 is not particularly limited, and may be selected as appropriate depending on, for example, the intended use of the strain gauge 1. For example, the substrate 10 may be approximately 5 micrometers (μm) to 500 μm thick. A strain-generating body may be joined to the inorganic insulating layer 70 end of the strain gauge 1 via a bonding layer or the like. Note that, from the perspectives of the transmission of strain from the surface of the strain-generating body to a sensing part and dimensional stability against environmental changes, the thickness of the substrate 10 is preferably within the range of 5 μm to 200 μm. Also, from the perspective of insulation, the thickness of the substrate 10 is preferably 10 μm or more.

The substrate 10 can be formed from an insulating resin film made of, for example, a polyimide (PI) resin, an epoxy resin, a polyether ether ketone (PEEK) resin, a polyethylene naphthalate (PEN) resin, a polyethylene terephthalate (PET) resin, a polyphenylene sulfide (PPS) resin, a liquid crystal polymer (LCP) resin, a polyolefin resin, and so forth. Note that a film herein refers to a flexible member that is approximately 500 μm thick or less.

When the substrate 10 is formed from an insulating resin film, the insulating resin film may contain fillers, impurities, and the like. For example, the substrate 10 may be formed from an insulating resin film containing a filler such as silica or alumina.

The resistor 30 is a thin film that is formed in a predetermined pattern on one side of the substrate 10 (the upper side in FIG. 1 and FIG. 2). In the strain gauge 1, the resistor 30 is a sensing part in which a change in resistance occurs when strain is applied. The resistor 30 may be formed directly on the upper surface 10a of the substrate 10, or may be formed over the upper surface 10a of the substrate 10 via another layer. Note that FIG. 1 shows the resistor 30 with a high-density dot pattern, for ease of understanding.

The resistor 30 formed is with multiple elongated parts positioned at predetermined intervals with their respective longitudinal directions all oriented in the same direction (the X direction in the example of FIG. 1), and the ends of adjacent elongated parts are alternately connected such that the resistor 30 forms a zigzag shape as a whole. The longitudinal direction of the elongated parts is the grid direction, and the direction perpendicular to the grid direction is the grid width direction (the Y direction in the example of FIG. 1).

In the resistor 30, the −X end of the elongated part located closest to the +Y end is bent in the +Y direction and ends at one end 30e; of the resistor 30 in the grid width direction. Also, the −X end of the elongated part located closest to the −Y end is bent in the −Y direction and ends at the other end 30ₑ₂ of the resistor 30 in the grid direction. The ends 30ₑ₁ and 30ₑ₂ of the resistor 30 in the grid width direction are electrically connected with the electrodes 50 via the conductive traces 40. In other words, the conductive traces 40 electrically connect the ends 30ₑ₁ and 30ₑ₂ of the resistor 30 in the grid width direction, with respective electrodes 50.

The resistor 30 can be formed from, for example, a material containing Cr (chromium), a material containing Ni (nickel), or a material containing both Cr and Ni. That is, the resistor 30 can be formed from a material containing at least one of Cr and Ni. Materials containing Cr include, for example, a Cr composite film. Materials containing Ni include, for example, Cu—Ni (copper nickel). Materials containing both Cr and Ni include, for example, Ni—Cr (nickel chromium).

Here, a Cr composite film refers to a composite film of Cr, CrN, Cr₂N, and the like. A Cr composite film may contain incidental impurities such as chromium oxide.

The thickness of the resistor 30 is not particularly limited, and may be determined as appropriate depending on, for example, the intended use of the strain gauge 1. For example, the thickness of the resistor 30 may be approximately 0.05 μm to 2 μm. In particular, when the thickness of the resistor 30 is 0.1 μm or more, the crystallinity of the crystals constituting the resistor 30 (for example, the crystallinity of α-Cr) is improved. Furthermore, when the thickness of the resistor 30 is 1 μm or less, (i) cracks in the film and (ii) warping of the film from the substrate 10, both caused by the internal stress of the film constituting the resistor 30, are reduced.

In order to not to allow the resistor 30 to have lateral sensitivity and prevent disconnection, the width of the resistor 30 preferably falls between 10 μm and 100 μm, inclusive. Furthermore, the width of the resistor 30 is preferably between 10 μm and 70 μm, inclusive, and more preferably between 10 μm and 50 μm, inclusive.

For example, when the resistor is a Cr composite film, the stability of gauge characteristics can be improved by using α-Cr (alpha chromium), which has a stable crystalline phase, as a main component. Additionally, when the resistor 30 is a Cr composite film and contains α-Cr as its main component, the strain gauge 1 can have a gauge factor of 10 or higher, as well as a gauge factor temperature coefficient TCS and a resistance temperature coefficient TCR in a range of −1,000 ppm/degrees Celsius to +1,000 ppm/degrees Celsius. Here, the term “main component” means that the substance of interest accounts for 50 percent (%) or more by weight or more of all the substances constituting the resistor 30. From the perspective of improving gauge characteristics, it is preferable if the resistor 30 contains 80% or more of α-Cr by weight thereof. From the same perspective, it is more preferable if the resistor 30 contains 90% or more of α-Cr by weight thereof. Note that α-Cr is Cr with a bcc structure (body-centered cubic lattice structure).

Furthermore, when the resistor 30 is a Cr composite film, the Cr composite film preferably contains 20% by weight or less of CrN and Cr₂N. CrN and Cr₂N in the Cr composite film are thus 20% by weight or less, so that a decrease in the gauge factor of the strain gauge 1 can be prevented or substantially prevented.

The proportion of CrN to Cr₂N in the Cr composite film is preferably determined such that the proportion of Cr₂N with respect to the total weight of CrN and Cr₂N is 80% or more by weight and less than 90% by weight. More preferably, the proportion of Cr₂N with respect to the total weight of CrN and Cr₂N is 90% by weight or more and less than 95% by weight. Cr₂N has semiconductor-like properties. Therefore, by setting the above-mentioned proportion of Cr₂N 90% or more by weight and less than 95% by weight, the decrease in TCR (negative TCR) becomes more noticeable. Furthermore, by setting the proportion of Cr₂N to 90% by weight or more and less than 95% by weight, the ceramization of the resistor 30 can be reduced, and the resistor 30 can be made less susceptible to brittle fracture.

On the other hand, CrN has the advantage of being chemically stable. By including a larger amount of CrN in the Cr composite film, the possibility of producing an unstable N can be reduced, and therefore a stable strain gauge can be achieved. Here, “unstable N” refers to a small amount of N₂ or atomic N that may be present in the Cr composite film. These unstable N can escape from the membrane depending on the external environment (for example, high temperature environment). When unstable N escapes from the film, the film stress of the Cr composite film can change.

In the strain gauge 1, when a Cr composite film is used as a material of the resistor 30, high sensitivity and miniaturization can be achieved. While the output of a conventional strain gauge has been about 0.04 mV/2 V, when a Cr composite film is used as a material of the resistor 30, an output of 0.3 mV/2 V or more can be achieved. In addition, while the size (gauge length×gauge width) of a conventional strain gauge has been approximately 3 mm×3 mm, when a Cr composite film is used as a material of the resistor 30, the size (gauge length×gauge width) can be reduced to approximately 0.3 mm×0.3 mm.

The conductive traces 40 are formed on a substrate 10. The conductive traces 40 are electrically connected to the resistor 30 and the electrodes 50. The conductive traces 40 are not limited to being straight lines, and can be formed in any pattern. Additionally, the conductive traces 40 can have any width and length. Note that, in FIG. 1, for ease of understanding, the conductive traces 40 are shown with a dot pattern that is less dense than the resistor 30.

The electrodes 50 are formed on the substrate 10. The electrodes 50 are electrically connected to the resistor 30 via the conductive traces 40. The electrodes 50 are formed wider than the conductive traces 40 and formed in a substantially rectangular shape in plan view. The electrodes 50 are a pair of electrodes for outputting strain-induced changes in the resistance value of the resistor 30 to the outside. For example, lead wires or the like for external connection are joined thereto to the electrodes 50. A metal layer having low resistance such as one made of copper, or a metal layer having good solderability such as one of gold, may be laminated on the upper surface of the electrodes 50. Although the resistor 30, conductive traces 40, and electrodes 50 are assigned different reference numerals for ease of understanding, they can be formed integrally from the same material in the same process. Note that, in FIG. 1, for ease of understanding, the electrodes 50 are shown with a dot pattern of the same density as the conductive traces 40.

A cover layer 60 (insulating resin layer) is provided on the upper surface 10a of the substrate 10, if necessary, so as to cover the resistor 30 and the conductive traces 40, and expose the electrodes 50. Examples of materials for the cover layer 60 include insulating resins such as a PI resin, an epoxy resin, a PEEK resin, a PEN resin, a PET resin, a PPS resin, or a composite resin (such as a silicone resin or a polyolefin resin). Note that the cover layer 60 may contain fillers or pigments. The thickness of the cover layer 60 is not particularly limited and can be selected as appropriate depending on, for example, the purpose of use. For example, the thickness of the cover layer 60 may be approximately 2 μm to 30 μm. By providing the cover layer 60, the resistor 30 can be prevented from, for example, getting mechanically damaged. Furthermore, by providing the cover layer 60, the resistor 30 can be protected from moisture and the like.

An inorganic insulating layer 70 is formed on the other side of the substrate 10 (in the example of FIG. 2, on the lower surface 10b side of the substrate 10). The inorganic insulating layer 70 is formed at least at a position that overlaps the grid region (the region where the resistor 30 is formed) in plan view. The inorganic insulating layer 70 may be formed over the entire lower surface 10b of the substrate 10. In the event the inorganic insulating layer 70 is formed only at a position that overlaps the grid region (the region where the resistor 30 is formed) in plan view, the area of the inorganic insulating layer 70 is reduced, which is an advantage because the risk of having cracks in the inorganic insulating layer 70 can be reduced.

Examples of materials for the inorganic insulating layer 70 include an oxide, a nitride, and an oxynitride of a metal such as Cu, Cr, Ni, Al, Fe, W, Ti, and Ta, as well as an alloy containing these metals. Examples of material for the inorganic insulating layer 70 may further include a semiconductor such as Si or Ge, or an oxide, a nitride, or an oxynitride thereof. The thickness of the inorganic insulating layer 70 is not particularly limited, and can be selected as appropriate depending on the purpose of use. For example, the inorganic insulating layer 70 may be approximately 0.5 μm to 625 μm thick. Within this range, the gauge factor of the strain gauge 1 can be kept at the same level as when the inorganic insulating layer 70 is not provided.

It is preferable if the strain gauge 1 has excellent creep characteristics. For example, if the creep characteristic of the strain gauge 1 can be reduced to a predetermined value or less, the strain gauge 1 can be used for weighing scales, in addition to sensors. The creep characteristics of the strain gauge 1 are affected by the viscoelasticity of the material it is made of. Generally, creep does not occur in a metallic material, which is an elastic material; creep, however, does occur in resin, which is a viscous material. Since the strain gauge 1 uses a resin substrate 10, the viscosity of the substrate 10 cannot be ignored.

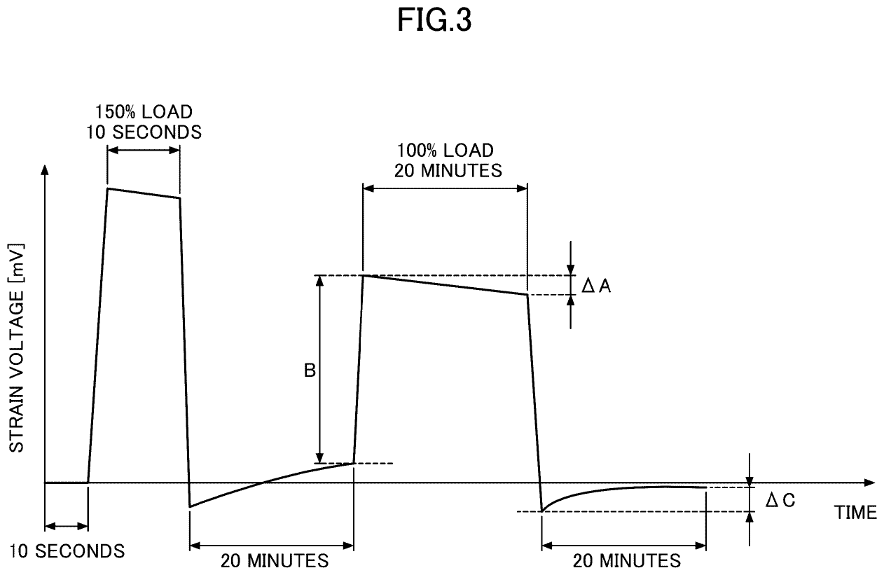

Since creep and creep recovery both refer to changes over time in the amount of elastic deformation (the amount of strain) of the surface of the strain gauge 1 over which the resistor 30 is formed, they can be measured by monitoring the strain voltage calculated based on an output between a pair of electrodes 50. A more detailed explanation will be given below with reference to FIG. 3.

FIG. 3 is a diagram illustrating a method of measuring creep and creep recovery. In FIG. 3, the horizontal axis is time, and the vertical axis is strain voltage [mV].

First, 10 seconds after the power supply to the measurement device is turned on, a load of 150% is applied to the strain gauge 1 attached to a strain-generating body, for 10 seconds, and then the load is removed. After 20 minutes have elapsed since the load was removed, a 100% load is applied to the strain gauge 1 attached to the strain-generating body, for 20 minutes, and then the load is removed. Then, the strain gauge 1 is left as is until 20 minutes elapse after the load is removed.

The strain voltage changes, for example, as shown in FIG. 3. In FIG. 3, the absolute value B of the difference between the strain voltage 20 minutes after the 150% load is removed and the strain voltage immediately after the 100% load is applied is measured. Also, the absolute value AA of the difference between the strain voltage immediately after the 100% load is applied and the strain voltage 20 minutes after the 100% load starts being applied is measured. Then, AA/B is the creep. Next, the absolute value AC of the difference between the strain voltage immediately after the 100% load is removed and the strain voltage 20 minutes after the 100% load is removed is measured. Then, AC/B is the creep recovery.

Note that the 100% load is 3 (kilograms) kg, and the 150% load is 1.5 times the 100% load.

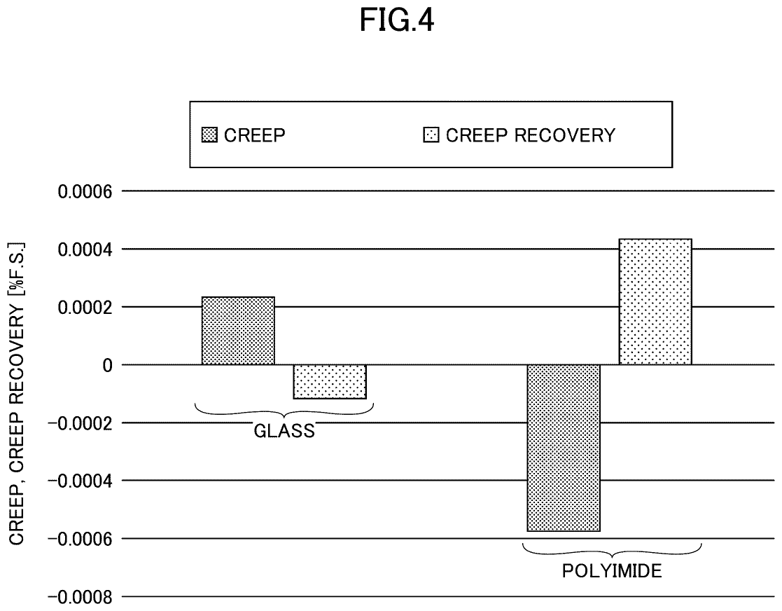

FIG. 4 shows the results of investigating creep and creep recovery. FIG. 4 summarizes the results of studying the creep and creep recovery of polyimide (PI) and glass (SiO₂) of the same shape using the measurement method illustrated in FIG. 3. The polyimide is 25 μm thick, and the glass is 100 μm thick.

As shown in FIG. 4, the glass has smaller creep and creep recovery than polyimide. Similar results are obtained when comparing resins other than polyimide with inorganic materials other than glass. In other words, when comparing resins with inorganic materials, inorganic materials, which have a higher modulus of elasticity and which therefore stretch less, can reduce the creep and creep recovery.

That is, even if the substrate 10 is made of resin, for example, an inorganic insulating layer 70 can be formed over the lower surface 10b of the substrate 10, so that, in the grid region, the substrate 10 is prevented or substantially prevented from expanding and contracting, and the creep characteristics of the strain gauge 1 are improved. In the event the substrate 10 of the strain gauge 1 is made of resin and a resin cover layer 60 is furthermore provided, the modulus of elasticity of the strain gauge 1 tends to be large on the whole; accordingly, providing an inorganic insulating layer 70 is particularly effective.

Note that, in the event of a highly sensitive strain gauge with, for example, a gauge factor of 10 or more being used (for example, when a Cr composite film is used for the resistor 30), the strain gauge is sensitive to the influence of material properties due to its high sensitivity, and its creep characteristics may be reduced significantly. Therefore, when a highly sensitive strain gauge having a gauge factor of 10 or more is used, it is extremely important to improve its creep characteristics by providing an inorganic insulating layer 70.

### [Method of Making Strain Gauge]

Here, the method of making the strain gauge 1 will be described. In order to make the strain gauge 1, first, a substrate 10 is prepared, and a metal layer (hereinafter referred to as “metal layer A” for ease of explanation) is formed over the upper surface 10a of the substrate 10. The metal layer A is a layer that is finally patterned to serve as the resistor 30, conductive traces 40, and electrodes 50. Therefore, the material and thickness of the metal layer A are the same as those of the resistor 30, conductive traces 40, and electrodes 50 described above.

The metal layer A can be formed, for example, by magnetron sputtering, in a raw material which can form the metal layer A that is used as a target. The metal layer A may be formed by using reactive sputtering, vapor deposition, arc ion plating, pulse laser deposition, and so forth, instead of magnetron sputtering.

From the perspective of achieving stable gauge characteristics, before forming the metal layer A, it is preferable to vacuum-form a functional layer of a predetermined thickness as an foundation layer, over the upper surface 10a of the substrate 10 by, for example, conventional sputtering.

In the present disclosure, a functional layer refers to a layer having a function of facilitating the crystal growth of at least the upper metal layer A (resistor 30). The functional layer preferably further has a function of preventing oxidation of the metal layer A due to the oxygen and moisture contained in the substrate 10, a function of improving the adhesion between the substrate 10 and the metal layer A, and so forth. The functional layer may also have other functions as well.

The insulating resin film that constitutes the substrate 10 contains oxygen and moisture. In particular, when the metal layer A contains Cr, Cr forms a self-autoxidized film, and so it is effective if the functional layer has a function of preventing oxidation of the metal layer A.

The material of the functional layer is not particularly limited as long as it at least has a function of facilitating the crystal growth of the metal layer A (resistor 30), which is an upper layer, and can be selected as appropriate depending on the purpose of use. The material may be, for example, one or more types of metals selected from the group consisting of Cr (chromium), Ti (titanium), V (vanadium), Nb (niobium), Ta (tantalum), Ni (nickel), Y (yttrium), Zr (zirconium), Hf (hafnium), si (silicon), C (carbon), Zn (zinc), Cu (copper), Bi (bismuth), Fe (iron), Mo (molybdenum), W (tungsten), Ru (ruthenium), Rh (rhodium), Re (rhenium), Os (osmium), Ir (iridium), Pt (platinum), Pd (palladium), Ag (silver), Au (gold), Co (cobalt), Mn (manganese), and Al (aluminum), an alloy of some of the metals in this group, or a compound of some of the metals in this group.

Examples of the above alloys include FeCr, TiAl, FeNi, NiCr, CrCu, and the like. Examples of the above compounds include TiN, TaN, Si₃N₄, TiO₂, Ta₂O₅, SiO₂, and the like.

When the functional layer is formed from a conductive material such as a metal or an alloy, the film thickness of the functional layer is preferably 1/20 or less of the film thickness of the resistor. When the film thickness of the functional layer is in this range, it is possible to facilitate the crystal growth of α-Cr, and prevent a situation where part of the current flowing in the resistor flows into the functional layer and causes a decrease in the sensitivity of strain detection.

When the functional layer is formed from a conductive material such as a metal or an alloy, the film thickness of the functional layer is more preferably 1/50 or less of the film thickness of the resistor. When the film thickness of the functional layer is in this range, it is possible to facilitate the crystal growth of α-Cr, and prevent, more effectively, a situation where part of the current flowing in the resistor flows into the functional layer and causes a decrease in the sensitivity of strain detection.

When the functional layer is formed from a conductive material such as a metal or an alloy, the film thickness of the functional layer is even more preferably 1/100 or less of the film thickness of the resistor. When the film thickness of the functional layer is in this range, it is possible to prevent, even more effectively, a situation where part of the current flowing in the resistor flows into the functional layer and causes a decrease in the sensitivity of strain detection.

When the functional layer is formed from an insulating material such as an oxide or a nitride, the film thickness of the functional layer is preferably 1 nm to 1 μm. When the film thickness of the functional layer is in this range, it is possible to facilitate the crystal growth of α-Cr, and form a film with ease without forming cracks in the functional layer.

When the functional layer is formed from an insulating material such as an oxide or a nitride, the film thickness of the functional layer is more preferably 1 nm to 0.8 μm. When the film thickness of the functional layer is in this range, it is possible to facilitate the crystal growth of α-Cr, and form a film even more easily without forming cracks in the functional layer.

When the functional layer is formed from an insulating material such as an oxide or a nitride, the film thickness of the functional layer is even more preferably 1 nm to 0.5 μm. When the film thickness of the functional layer is in this range, it is possible to facilitate the crystal growth of α-Cr, and form a film even more easily without forming cracks in the functional layer.

Note that the plan shape of the functional layer is patterned substantially the same as the plan shape of the resistor illustrated in FIG. 1, for example. However, the plan shape of the functional layer does not necessarily have to be substantially the same as the plan shape of the resistor. When the functional layer is formed from an insulating material, the plan shape of the functional layer does not have to be patterned in the same shape as the plan shape of the resistor. In this case, the functional layer may be formed in a solid shape at least in the part where the resistor is formed. Alternatively, the functional layer may be formed in a solid shape over the entire upper surface of the substrate 10.

Also, when the functional layer is formed from an insulating material, the functional layer may be made relatively thick, such as 50 nm thick or more and 1 μm thick or less, and may be formed in a solid shape, so that the thickness and the surface area of the functional layer increase, and the heat that is generated by the resistor can be readily dissipated to the substrate 10 side. As a result of this, with the strain gauge 1, it is possible to reduce the decrease of the accuracy of measurement due to the resistor's self-heating.

The functional layer can be vacuum-formed by, for example, conventional sputtering, in which a raw material that can form the functional layer is the target and an Ar (argon) gas is introduced into a chamber. By using conventional sputtering, the functional layer is formed while the upper surface 10a of the substrate 10 is being etched with Ar, and therefore it is possible to form the functional layer only in a minimal amount, and achieve an effect of improving adhesion.

However, this is simply one example method of forming the functional layer, and the functional layer may be formed by using other methods as well. For example, a method may be used here in which, before the functional layer is formed, the upper surface 10a of the substrate 10 is activated by plasma treatment using Ar or the like, so as to gain an adhesion improving effect, and in which, subsequently, the functional layer is vacuum-formed by magnetron sputtering.

The combination of the material of the functional layer and the material of the metal layer A is not particularly limited, and can be selected as appropriate depending on the purpose of use. For example, it is possible to form a Cr composite film by using Ti as the functional layer and α-Cr (alpha-chromium) as the main component of the metal layer A.

In this case, the metal layer A can be formed by magnetron sputtering, in which a raw material that can form the Cr composite film is the target and an Ar gas is introduced into a chamber. Alternatively, reactive sputtering, which targets pure Cr and introduces an appropriate amount of nitrogen gas into a chamber with an Ar gas, may be used to form the metal layer A. In this case, by changing the amount of nitrogen gas to be introduced, its pressure (nitrogen partial pressure) and so forth, and by adjusting the heating temperature by providing a heating step, it becomes possible to adjust the proportions of CrN and Cr₂N contained in the Cr composite film, as well as the proportion of Cr₂N in CrN and Cr₂N.

According to these methods, the growth surface of the Cr composite film is defined and triggered by a functional layer made of Ti and a Cr composite film, in which α-Cr having a stable crystalline structure is the main component, can be formed. Also, Ti that constitutes the functional layer is diffused in the Cr composite film, so that improved gauge characteristics can be gained. For example, the gauge factor of the strain gauge 1 can be made 10 or greater, and the gauge factor temperature coefficient TCS and the resistance temperature coefficient TCR can be kept in the range of −1,000 ppm/degrees Celsius to +1,000 ppm/degrees Celsius. Note that, when the functional layer is formed from Ti, the Cr composite film might contain Ti or TiN (titanium nitride).

Note that, when the metal layer A is a Cr composite film, the functional layer made of Ti has all of the function of facilitating the crystal growth of the metal layer A, the function of preventing oxidation of the metal layer A due to the oxygen or moisture contained in the substrate 10, and the function of improving the adhesion between the substrate 10 and the metal layer A. The same applies when Ta, Si, Al, or Fe is used for the functional layer, instead of Ti.

In this way, by providing a functional layer in a lower layer of the metal layer A, it becomes possible to facilitate the crystal growth of the metal layer A, and prepare a metal layer A that is made of a stable crystalline phase. As a result of this, the stability of gauge characteristics in the strain gauge 1 can be improved. Furthermore, since the material to constitute the functional layer is diffused in the metal layer A, the strain gauge 1 can have improved gauge characteristics.

Next, the metal layer A is patterned by photolithography to form the resistor 30, two conductive traces 40, and two electrodes 50, each having a planar shape as shown in FIG. 1.

Next, an inorganic insulating layer 70 is formed over the lower surface 10b of the substrate 10 at least at a position that overlaps the grid region in plan view. The material and thickness of the inorganic insulating layer 70 are as described above. The method of forming the inorganic insulating layer 70 is not particularly limited and can be selected as appropriate depending on, for example, the purpose of use. For example, the inorganic insulating layer 70 can be formed by vacuum processing such as sputtering, plating, or chemical vapor deposition (CVD), or by solution processing such as spin coating or a sol-gel method. After the inorganic insulating layer 70 is formed, it may be patterned by photolithography, if necessary. Note that the inorganic insulating layer 70 may be formed at other times as well. For example, the inorganic insulating layer 70 may be formed before the metal film A is formed.

After the resistor 30, the conductive traces 40, and the electrodes 50 are formed, a cover layer 60 may be formed over the upper surface 10a of the substrate 10. The cover layer 60 covers the resistor 30 and the conductive traces 40, but the electrodes 50 may be exposed from the cover layer 60. For example, a semi-cured thermosetting insulating resin film can be laminated over the upper surface 10a of the substrate 10, so as to cover the resistor 30 and the conductive traces 40 and expose the electrodes 50, and then the insulating resin film can be heated and cured to form the cover layer 60. Through the above steps, the strain gauge 1 is completed.

Note that, when a functional layer is formed over the upper surface 10a of the substrate 10 as a foundation layer for the resistor 30, the conductive traces 40, and the electrodes 50, the strain gauge 1 has the cross-sectional shape shown in FIG. 5. The layer assigned the reference numeral 20 is the functional layer. The plan shape of the strain gauge 1 when the functional layer 20 is provided is, for example, the same as shown in FIG. 1. However, as described above, the functional layer 20 may in some cases be formed in a solid shape in part of all of the upper surface 10a of the substrate 10.

### Variation 1 of the First Embodiment

A variation 1 of the first embodiment shows an example of a strain gauge in which an inorganic insulating layer is provided at a position that is different from that of the first embodiment. Note that in variation 1 of the first embodiment, parts that are the same as in the embodiment described may not be described again.

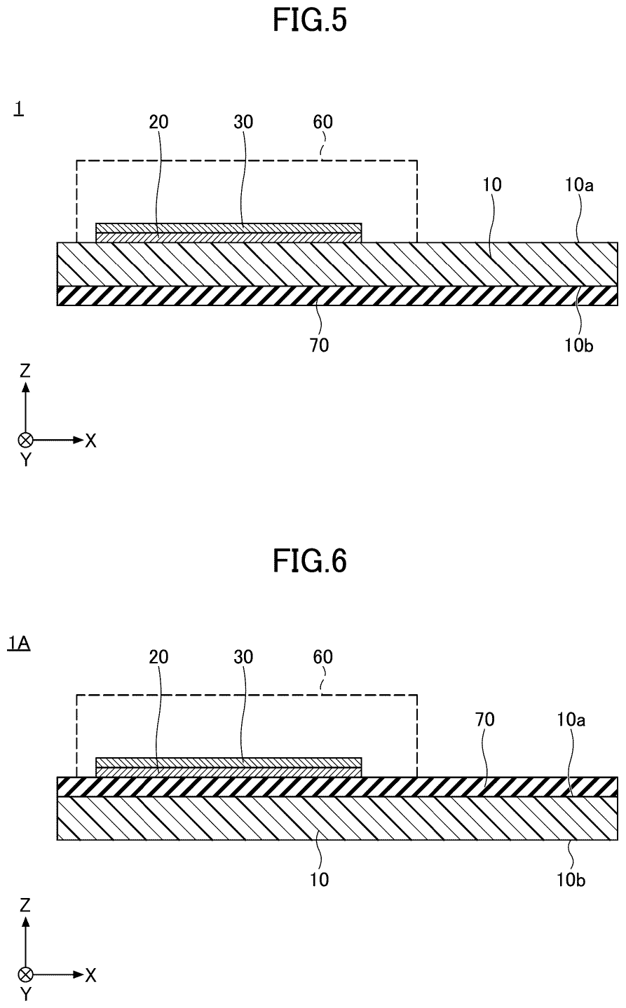

FIG. 6 is a cross-sectional view illustrating a strain gauge according to variation 1 of the first embodiment. Referring to FIG. 6, the strain gauge 1A differs from the strain gauge 1 shown in FIG. 5 in that an inorganic insulating layer 70 is formed over the upper surface 10a of the substrate 10, and a functional layer 20 and a resistor 30 are laminated in order on the inorganic insulating layer 70.

The inorganic insulating layer 70 has only to be located at least at a position (the region where the resistor 30 is formed) that overlaps the grid region in plan view. The inorganic insulating layer 70 may be provided over the entire upper surface 10a of the substrate 10.

In the strain gauge 1A, the inorganic insulating layer 70 and the functional layer 20 are formed from different materials. The inorganic insulating layer 70 and the functional layer 20 may be formed only at a position that overlaps the region where the resistor 30 is formed in plan view.

When the functional layer 20 is made of a conductive material, the planar shape of the functional layer 20 is patterned to be substantially the same as the planar shape of the resistor 30. When the functional layer 20 is made of an insulating material, the planar shape of the functional layer 20 need not be patterned into the same shape as the planar shape of the resistor 30. In this case, the functional layer 20 may be formed in a solid shape in at least the grid region where the resistor 30 is formed. Alternatively, the functional layer 20 may be formed in a solid shape over the entire upper surface of the inorganic insulating layer 70.

In this way, even if the substrate 10 is made for example, by providing an inorganic of resin, insulating layer 70 on the upper surface 10a of the substrate 10, it is possible to prevent or substantially prevent the substrate 10 in the grid region from expanding and contracting, so that the creep characteristics of the strain gauge 1A are improved.

Although a preferred embodiment has been described above, the embodiment and other examples described above are by no means limiting, and a variety of alterations and replacements may be made to the embodiment and examples herein without departing from the scope of the claims attached herewith.

This international application claims priority to Japanese Patent Application No. 2022-006257, filed Jan. 19, 2022, the entire contents of which are incorporated herein by reference.

### REFERENCE SIGNS LIST

1, 1A strain gauge
10 substrate
10a upper surface
10b lower surface
20 functional layer
30 resistor
40 conductive trace
50 electrode
60 cover layer
70 inorganic insulating layer

1. A strain gauge comprising:
a resin substrate;
a resistor formed of a film containing Cr, CrN, and Cr₂N on one side of the substrate; and
an inorganic insulating layer formed on another side of the substrate,
wherein the inorganic insulating layer is formed at least at a position overlapping a region where the resistor is formed in plan view.

2. The strain gauge according to claim 1, wherein a functional layer is formed over one surface of the substrate as a foundation layer for the resistor.

3. A strain gauge comprising:
a resin substrate;
an inorganic insulating layer formed on one side of the substrate; and
a functional layer and a resistor laminated sequentially on the inorganic insulating layer,
wherein the resistor is formed of a film containing Cr, CrN, and Cr₂N,
wherein the inorganic insulating layer and the functional layer are formed from different materials, and
wherein the inorganic insulating layer is formed at least at a position overlapping a region where the resistor is formed in plan view.

4. The strain gauge according to claim 2, wherein the inorganic insulating layer and the functional layer are formed only at the position overlapping the region where the resistor is formed in plan view.

5. The strain gauge according to claim 2, wherein the resistor is formed directly over one surface of the functional layer.

6. The strain gauge according to claim 1, further comprising an insulating resin layer covering the resistor.

7. The strain gauge according to claim 1, wherein a gauge factor is 10 or higher.

8. The strain gauge according to claim 3, wherein the inorganic insulating layer and the functional layer are formed only at the position overlapping the region where the resistor is formed in plan view.

9. The strain gauge according to claim 3, wherein the resistor is formed directly over one surface of the functional layer.
